(19) United States
(12) Patent Application Publication
(10) Pub. No.: US 2026/0124832 A1
(43) Pub. Date: May 7, 2026

(54) SUBSTRATE JOINING METHOD, SUBSTRATE ASSEMBLY, AND INKJET PRINT HEAD

(71) Applicant: CANON KABUSHIKI KAISHA, Tokyo (JP)

(72) Inventor: YU KATANO, Kanagawa (JP)

(21) Appl. No.: 19/372,661

(22) Filed: Oct. 29, 2025

(30) Foreign Application Priority Data
Nov. 7, 2024 (JP) 2024-195383

(51) Int. Cl. B41J 2/16

(52) U.S. Cl. CPC B41J 2/1623; B41J 2/162

(57) ABSTRACT

A joining method includes the steps of applying a first adhesive in a line shape to a joining area of a first substrate, applying a second adhesive in a broken line shape to the joining area of the first substrate, at a predetermined interval from the first adhesive layer in the line shape, to form multiple second adhesive layers with a gap formed due to the broken line shape, bonding the second substrate to the first substrate with the first adhesive layer and the multiple second adhesive layers and pressure-bonding the second substrate to the first substrate, curing the multiple second adhesive layers between the first substrate and the second substrate pressure-bonded, and curing the first adhesive layer after the multiple second adhesive layers are cured.

### BACKGROUND

### Field of the Technology

The present disclosure relates to a substrate joining method, a substrate assembly, and an inkjet print head, and more specifically relates to a technique for bonding substrates together by using temporary fixing with a thermosetting adhesive.

### Description of the Related Art

Japanese Patent Laid-Open No. 2010-82537 (hereinafter referred to as Patent Literature 1) describes a technique for bonding substrates together by using a main adhesive which is thermosetting and has a relatively high adhesive strength and a temporary adhesive which is also thermosetting. In Patent Literature 1, the temporary adhesive is spot-applied to the joining surfaces of the substrates and is cured to temporarily bond the substrates together in a step before the main adhesive is cured. However, in a case where the spot application is used to bond a substrate with low wettability, such as a semiconductor substrate for use in, for example, an inkjet head, to another substrate, it is difficult to control an amount of the adhesive applied, resulting in an unstable amount of the adhesive applied. In addition, even though the adhesive is applied, it is difficult to obtain a desired adhesive strength.

In contrast, in a case where an adhesive is applied in a line shape, it is possible to stably control the amount of the adhesive applied, and therefore also to ensure the adhesive strength of the adhesive.

However, in a case where a line-shaped main adhesive and the line-shaped temporary adhesive are applied close to each other, an air bubble may be trapped between the two adhesives. Then, in the process of thermally curing the main adhesive, this trapped air bubble expands and generates a leak path passing through the main adhesive, which may cause defects in products manufactured by using the bonded substrates.

### SUMMARY

The disclosure intends to provide a substrate joining method of bonding substrates together without generating a leak path, a substrate assembly, and an inkjet print head.

The disclosure relates to a joining method including the steps of applying a first adhesive in a line shape to a joining area of a first substrate, applying a second adhesive in a broken line shape to a joining area of the first substrate, at a predetermined interval from the first adhesive layer in the line shape, to form multiple second adhesive layers with a gap formed due to the broken line shape, bonding a second substrate to the first substrate with the first adhesive layer and the plurality of second adhesive layers and pressure-bonding the second substrate to the first substrate, curing the multiple second adhesive layers between the first substrate and the second substrate pressure-bonded, and curing the first adhesive layer after the multiple second adhesive layers are cured.

Features of the present disclosure will become apparent from the following description of embodiments with reference to the attached drawings. The following description of embodiments is described by way of example.

### BRIEF DESCRIPTION OF THE DRAWINGS

FIG. 1A is a top view illustrating a state where a temporary adhesive and a main adhesive are applied to a joining surface of a substrate to be joined according to a comparative example;

FIG. 1B is a top view illustrating a state where the temporary adhesive and the main adhesive are applied to the joining surface of the substrate to be joined according to the comparative example;

FIG. 1C is a top view illustrating a state where the temporary adhesive and the main adhesive are applied to the joining surface of the substrate to be joined according to the comparative example;

FIG. 1D is a top view illustrating a state where the temporary adhesive and the main adhesive are applied to the joining surface of the substrate to be joined according to the comparative example;

FIG. 1E is a top view illustrating a state where the temporary adhesive and the main adhesive are applied to the joining surface of the substrate to be joined according to the comparative example;

FIG. 2A is a cross-sectional view taken alone a line A-A in FIG. 1A;

FIG. 2B is a cross-sectional view taken alone a line A-A in FIG. 1B;

FIG. 2C is a cross-sectional view taken alone a line A-A in FIG. 1C;

FIG. 2D is a cross-sectional view taken alone a line A-A in FIG. 1D;

FIG. 2E is a cross-sectional view taken alone a line A-A in FIG. 1E;

FIGS. 3A and 3B are plan views illustrating two substrates to be joined and joining areas according to an embodiment;

FIG. 4 is a flowchart presenting processing of bonding a first substrate and a second substrate together according to the embodiment;

FIG. 5A is a view for explaining application of a main adhesive to a first subtract in step 401 in FIG. 4;

FIG. 5B is an enlarged view illustrating a part of the first substrate illustrated in FIG. 5A;

FIG. 6A is a view for explaining application of a temporary adhesive to the first substrate in step 402 in FIG. 4;

FIG. 6B is an enlarged view illustrating a part of the first substrate illustrated in FIG. 6A;

FIG. 7 is a view for explaining an operation of pressure-bonding a second substrate to the first substrate in step 403;

FIG. 8A is a view illustrating processing of joining the first substrate and the second substrate according to the embodiment;

FIG. 8B is a view for explaining a change in the shapes of the main adhesive and the temporary adhesive during the processing of joining the first substrate and the second substrate in FIG. 4;

FIG. 8C is a view for explaining a change in the shapes of the main adhesive and the temporary adhesive during the processing of joining the first substrate and the second substrate in FIG. 4;

FIG. 8D is a view for explaining a change in the shapes of the main adhesive and the temporary adhesive during the processing of joining the first substrate and the second substrate in FIG. 4;

FIG. 8E is a view for explaining a change in the shapes of the main adhesive and the temporary adhesive during the processing of joining the first substrate and the second substrate in FIG. 4;

FIGS. 9A and 9B are views for explaining application of adhesives according to other embodiments;

FIGS. 10A and 10B are views for explaining application of adhesives according to other embodiments;

FIGS. 11A and 11B are views illustrating a first substrate before pressure-bonding according to a comparative example in which a gap is not provided in application of a temporary adhesive;

FIGS. 12A and 12B are views illustrating the pressure-bonded first substrate according to the comparative example in which the gap is not provided in the application of the temporary adhesive; and

FIG. 13 is an explanatory view illustrating an inkjet print head according to the embodiment.

### DESCRIPTION OF THE EMBODIMENTS

Hereinafter, embodiments of the invention will be described in detail with reference to the accompanying drawings. It should be noted that the dimensions, materials, shapes, and relative positions of constituent components described in the embodiments should be altered as appropriate depending on a structure, various conditions, and so on of an apparatus to which the invention is applied, and do not intend to limit the scope of the invention to the embodiments described below.

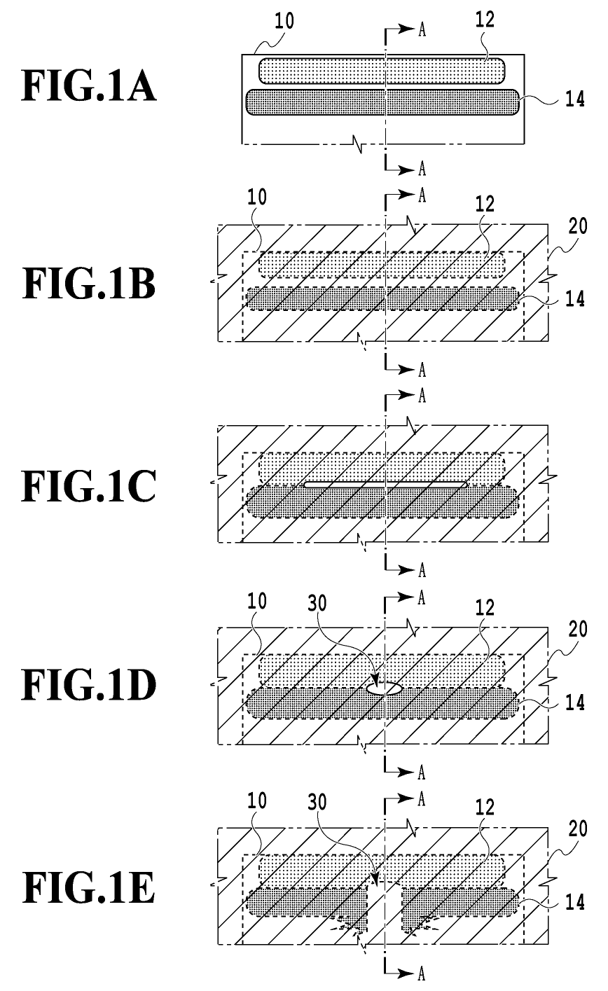

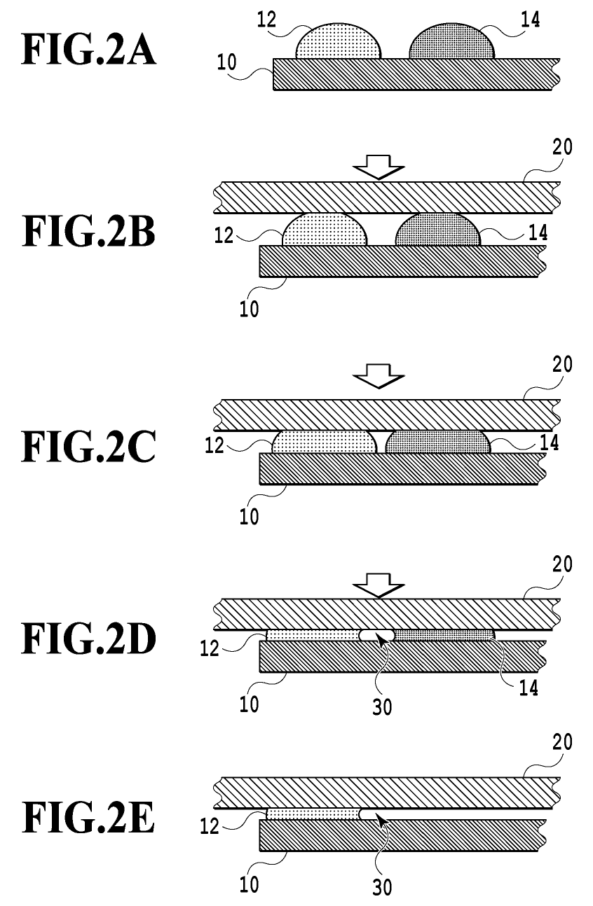

Prior to description of the embodiments of the invention, the generation of a leak path in a case where a temporary adhesive and a main adhesive are applied in line shapes in close proximity to each other for bonding is first explained with reference to a comparative example illustrated in FIGS. 1A to 1E and 2A to 2E. FIGS. 1A to 1E are top views illustrating states in which a temporary adhesive and a main adhesive are applied to a joining surface of a substrate to be joined according to the comparative example, and FIGS. 2A to 2E are cross-sectional views taken along lines A-A in FIG. 1, corresponding to FIGS. 1A to 1E, respectively.

In an applying/bonding step, first, a main adhesive (also called a first adhesive) 14 and a temporary adhesive (also called a second adhesive) 12 are applied in line shapes to a substrate 10 so as to be positioned in parallel at a small interval from each other (FIGS. 1A and 2A), and the substrate 10 and a substrate 20 to be joined are joined to each other (FIGS. 1B and 2B). In this state, the substrate 20 is pressure-bonded to the substrate 10 (FIGS. 1C and 2C). Then, only the temporary adhesive 12 is cured by thermocompression bonding such that the substrate 10 is temporarily fixed to the substrate 20 (FIGS. 1C and 2C). Next, the substrates 10 and 20 joined by the temporary fixing are heated in an oven, so that the main adhesive is cured (FIGS. 1D and 2D).

Here, in the process of applying the main adhesive 14 and the temporary adhesive 12 in the line shapes to the substrate 10, an application apparatus applies the adhesives while moving along the lines. In this process, the amount of each adhesive applied in the line shape may increase at the start and the end of the application because of acceleration and deceleration of an application speed. In this case, during the pressure-bonding illustrated in FIGS. 1C and 2C, the temporary adhesive 12 and the main adhesive 14 merge together at their both ends, the air left between the temporary adhesive 12 and the main adhesive 14 is eventually trapped as an air bubble 30 illustrated in FIGS. 1D and 2D.

As a result, the trapped air bubble 30 illustrated in FIGS. 1D and 2D expands during heating of the substrates 10 and 20 in the oven. Since the temporary adhesive 12 has already cured but the main adhesive 14 is in the middle of curing, the expanding air bubble 30 breaks through the softer main adhesive 14 and forms a leak path (FIGS. 1E and 2E). In an example in which the adhesives are applied in rectangular frame shapes and thereby used for the purpose of separating the inside and the outside of the adhesives, like, for example, joining of semiconductor substrates in an inkjet print head, such a leak path is problematic because an ink may reach the temporary adhesive on the outer side via the leak path. As a result, the temporary adhesive with relatively low ink resistance may cause peeling-off or the like and allow the ink to reach and short out an electrical wiring portion arranged outside the rectangular frame shape, thereby bringing about a defect in a product.

The embodiments of the disclosure intend to prevent formation of a leak path by a trapped air bubble described above.

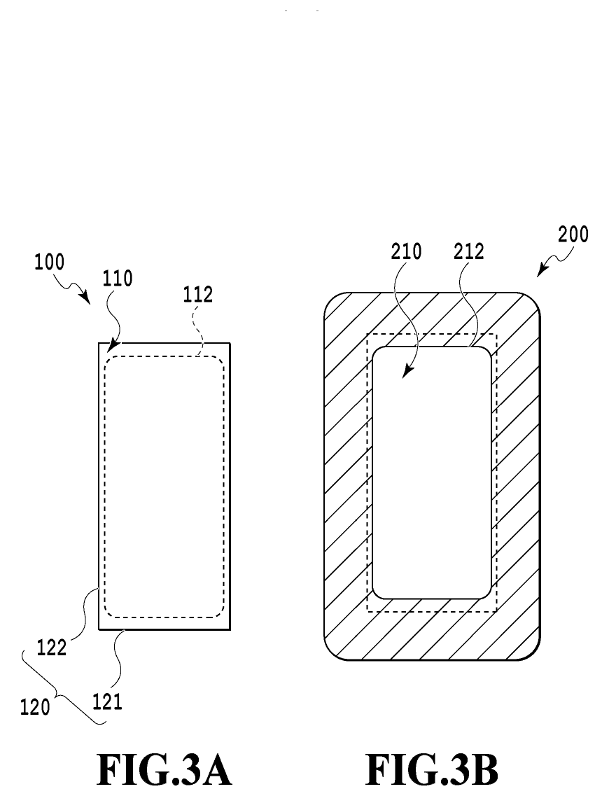

FIGS. 3A and 3B are plan views illustrating two substrates to be joined and joining areas according to an embodiment. A surface of a first substrate 100 illustrated in FIG. 3A has a joining area 110 and adhesives may be applied to the joining area 110. Specifically, the joining area 110 is an area formed on the surface of the first substrate 100 along sides 120 of the first substrate 100. In the embodiment, the first substrate 100 is a semiconductor substrate having external connection wiring terminals. On the other hand, a second substrate 200 illustrated in FIG. 3B has a rectangular opening 210. In the embodiment, the second substrate 200 is a thermally-conductive metal substrate. An outer periphery 212 of the opening 210 corresponds to an inner periphery 112 of the joining area 110 of the first substrate 100. In a case where adhesives are applied to the joining area 110, the inner periphery 112 of the joining area 110 of the first substrate 100 and the outer periphery 212 of the opening 210 of the second substrate 200 are aligned with each other and bonded together. Then, the adhesives are cured to fix the first substrate 100 to the second substrate 200.

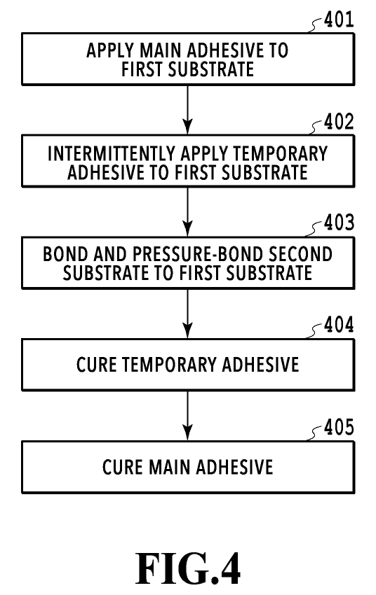

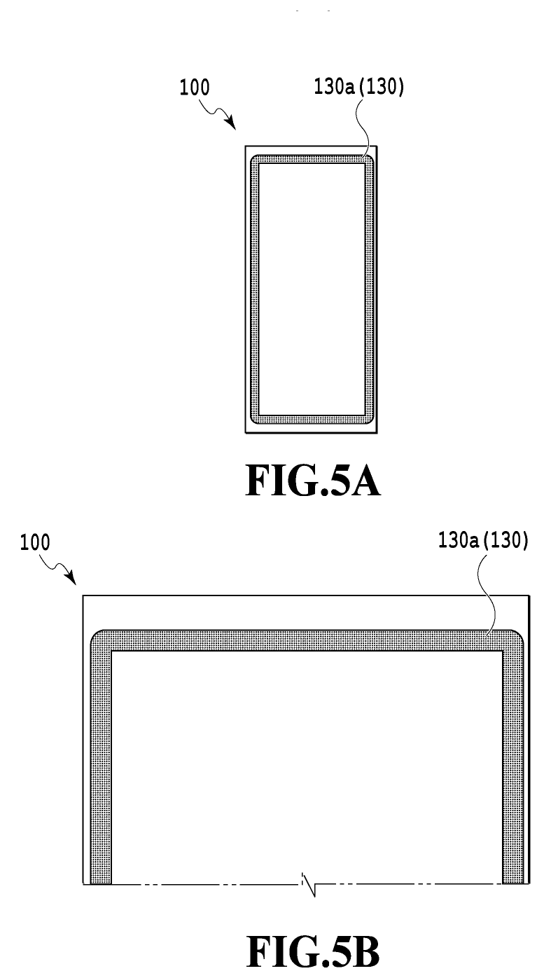

FIG. 4 is a flowchart presenting processing of joining the first substrate 100 and the second substrate 200 together according to the embodiment. First, in step 401, a main adhesive 130 is applied to the joining area 110 of the first substrate 100. FIGS. 5A and 5B are views for explaining this application, and FIG. 5B is an enlarged view of a part of the first substrate 100 illustrated in FIG. 5A. As illustrated in FIGS. 5A and 5B, the main adhesive 130 is applied in a line shape along the inner periphery 112 (inner boundary) of the joining area 110 of the first substrate 100. In the embodiment, the main adhesive 130 is a thermosetting adhesive having a relatively high adhesive strength and a relatively long curing time.

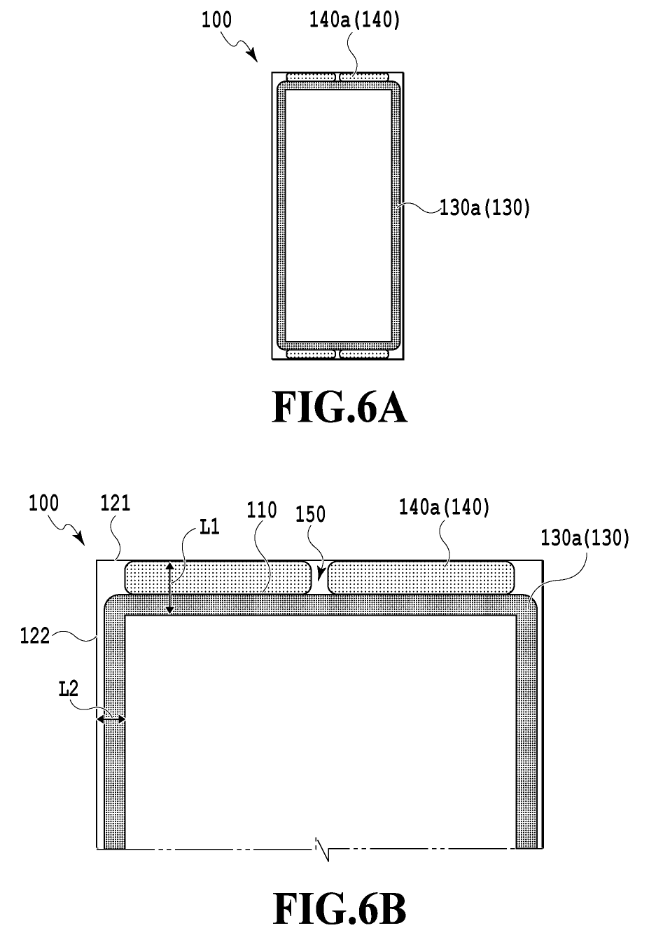

Next, in step 402, a temporary adhesive 140 is intermittently applied to the first substrate 100 in sub-areas located at a predetermined interval from the main adhesive 130 on the joining area 110. FIGS. 6A and 6B are views for explaining this application, and FIG. 6B is an enlarged view of a part of the first substrate 100 illustrated in FIG. 6A. As illustrated in FIGS. 6A and 6B, the temporary adhesive 140 is applied at a predetermined small distance outside the sub-area, to which the main adhesive 130 is applied, on the joining area 110 of the first substrate 100. Such intermittent application of the temporary adhesive 140 forms a gap 150 between the adjacent portions of the temporary adhesive 140. Note that, since the application apparatus performs this operation of applying the temporary adhesive 140 while moving along a straight line (in the horizontal direction in FIGS. 6A and 6B), at least the ends of the adjacent portions of the temporary adhesive 140 are not affected by the acceleration and deceleration of the application apparatus described above, and therefore the amounts of the adhesive applied at the ends are not increased.

In the embodiment, the temporary adhesive 140 is an adhesive that is curable within a short time, and the temporary adhesive 140 is, for example, a thermosetting adhesive having a shorter curing time and a lower curing temperature than the main adhesive 130. In another embodiment, the temporary adhesive 140 may be an ultraviolet ray-curable adhesive having a short curing time.

As illustrated in FIG. 6A, the temporary adhesive 140 in the embodiment is applied along two opposite short sides 121 of the first substrate 100 (in other words, the outer periphery of the joining area 110). Here, a portion of the joining area 110 adjacent to each of the short sides 121 of the first substrate 100 has a first length L₁ on which both the main adhesive 130 and the temporary adhesive 140 are to be applied, whereas a portion of the joining area 110 adjacent to each of long sides 122 of the first substrate 100 has a second length L₂ on which only the main adhesive 130 is to be applied. The second length L₂ is shorter than the first length L₁. This allows efficient use of the portions of the first substrate 100 to which both the main adhesive 130 and the temporary adhesive 140 are not applied. In the embodiment, the first length L₁ is about 1 mm.

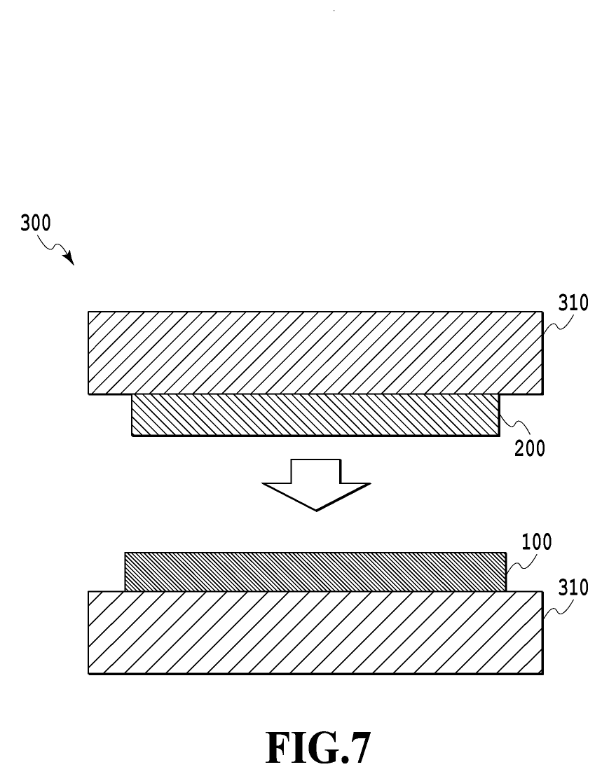

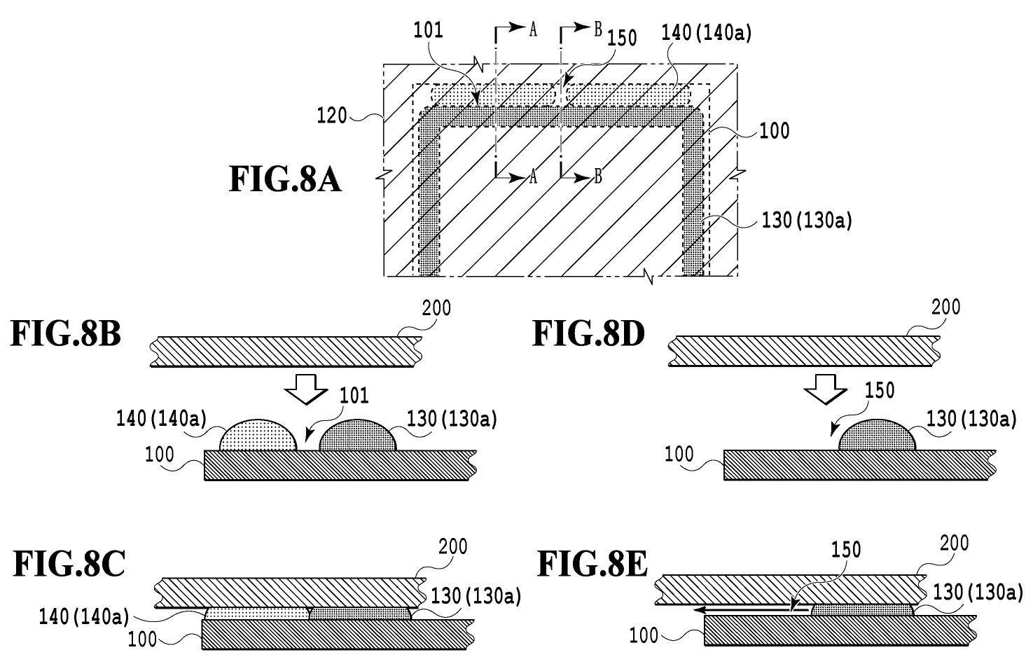

Referred to FIG. 4 again, in step 403, the second substrate 200 is pressure-bonded to the first substrate 100. FIG. 7 is a view for explaining this pressure-bonding operation. As illustrated in FIG. 7, a pressure-bonding apparatus 300 aligns the second substrate 200 with the first substrate 100, brings the first substrate 100 and the second substrate 200 close to each other, bonds the second substrate 200 to the first substrate 100 using the temporary adhesive 140 and the main adhesive 130, and pressure-bonds the second substrate 200 to the first substrate 100. Specifically, negative pressure is applied to the first substrate 100 and the second substrate 200 through suction holes (not illustrated) of two opposite fingers 310 of the pressure-bonding apparatus 300, and the first substrate 100 and the second substrate 200 are suctioned to the respectively corresponding fingers 310. In this operation, the surface of the first substrate 100 to which the main adhesive 130 and the temporary adhesive 140 are applied is positioned substantially in parallel with the surface of the second substrate 200 opposite to the former surface. Then, the pressure-bonding apparatus 300 aligns the joining area 110 of the first substrate 100 with the second substrate 200, and the two fingers 310 of the pressure-bonding apparatus 300 come close to each other in directions perpendicular to the surfaces of the first substrate 100 and the second substrate 200 (see FIG. 8B).

Next, in step 404, the sub-area to which the temporary adhesive 140 is applied is heated with the first substrate 100 pressure-bonded to the second substrate 200, so that only the temporary adhesive 140 is cured. Specifically, in the process where the pressure-bonding apparatus 300 illustrated in FIG. 7 bonds and pressure-bonds the second substrate 200 onto the first substrate 100, and a heater (not illustrated) installed in the finger 310 heats the second substrate 200, which is the metal substrate, to raise the temperature of the second substrate 200 to heat the temporary adhesive 140, so that temporary adhesive layers (also referred to as second adhesive layers) 140a are cured once the heating temperature reaches the curing temperature of the temporary adhesive 140. In this step, the main adhesive 130 is not cured because its curing temperature is higher than the curing temperature of the temporary adhesive 140. The scheme of curing the temporary adhesive 140 is not limited to this example. For example, a scheme of heating only the temporary adhesive 140 may be used. In this scheme, the curing temperature of the main adhesive 130 does not have to be higher than the curing temperature of the temporary adhesive 140.

Subsequently, in step 405, the main adhesive 130 is cured. Specifically, the first substrate and the second substrate joined together with the temporary adhesive 140 are placed in an oven and a whole of the joined substrates is heated to the curing temperature of the main adhesive. With this heating, a main adhesive layer (also referred to as a first adhesive layer) 130a formed of the main adhesive 130 is cured.

FIGS. 8B to 8E are views for explaining changes in the shapes of the main adhesive 130 and the temporary adhesive 140 during the processing of joining the first substrate 100 and the second substrate 200 described above in FIG. 4. FIG. 8A is a view illustrating the processing of joining the first substrate 100 and the second substrate 200 together according to the embodiment, FIGS. 8B and 8C illustrate cross sections taken along a line A-A in FIG. 8A, and FIGS. 8D and 8E illustrate cross sections taken along a line B-B in FIG. 8A.

In a region illustrated in FIGS. 8B and 8C, the main adhesive 130 and the temporary adhesive 140 come closer to each other while narrowing a distance between them in the process of pressure-bonding. In this process, since the ends of the main adhesive 130 and the temporary adhesive 140 are not joined, air present between the adhesives moves in a space 101 along these adhesives, and flows out to the outside via the gap 150 between the ends of the temporary adhesive 140. On the other hand, in a region presented in FIGS. 8D and 8E, the gap 150 exists, which means that there is no room for an air bubble to be trapped, and the gap 150 serves as an outlet for the air moving in the space 101 along the adhesives as mentioned above.

In the embodiment, the two adjacent cured temporary adhesive layers 140a are out of contact with each other, and the gap 150 communicates with the outside of the substrate assembly. Thus, the air present between the main adhesive layer 130a and the temporary adhesive layers 140a may be released to the outside from the gap 150. In another embodiment, in a case where air present between the main adhesive layer 130a and the temporary adhesive layers 140a flows into the gap 150 but no air bubble is trapped by the uncured main adhesive layer 130a, the two adjacent cured temporary adhesive layers 140a may be in contact with each other and close one end of the gap 105.

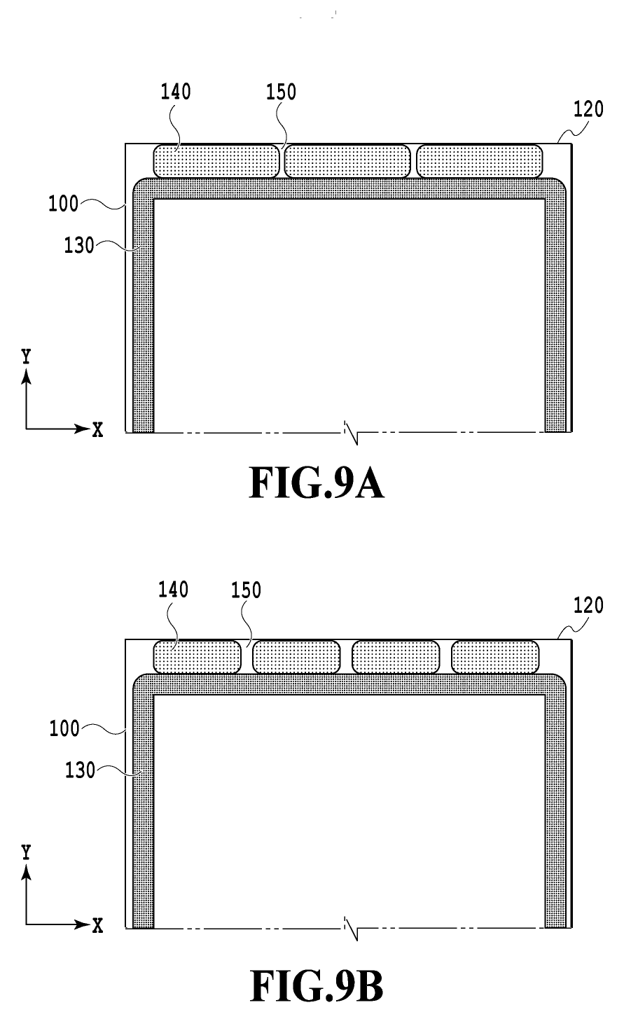

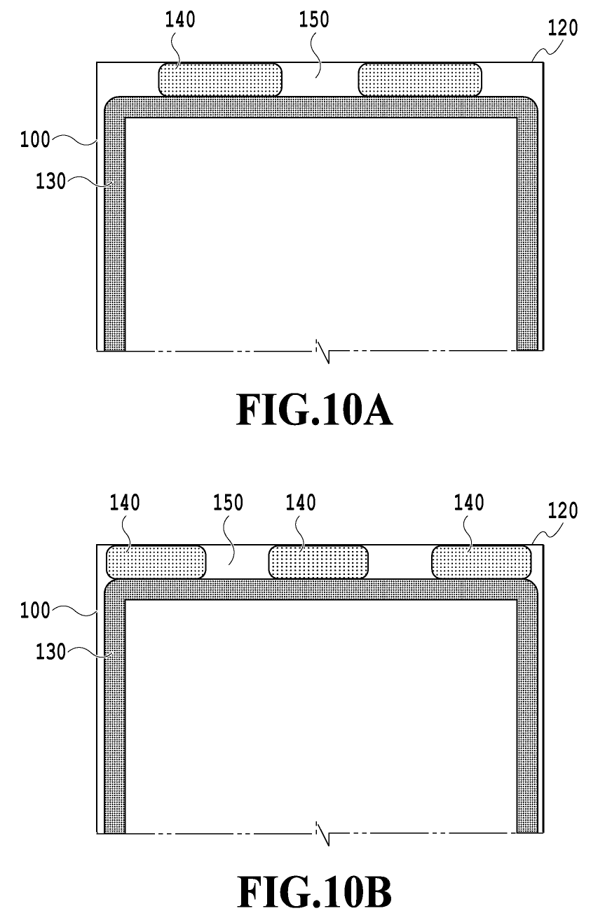

FIGS. 9A, 9B, 10A, and 10B are views for explaining application of adhesives according to other embodiments of the disclosure. FIGS. 9A and 9B illustrate schemes in which the number of gaps 150 in the intermittent application is increased, and FIGS. 10A and 10B illustrate schemes in which the length of each gap 150 is widened. These schemes allow air present between the main adhesive layer 130a and the temporary adhesive layers 140a to easily escape therefrom, thereby enhancing an effect of preventing an air bubble from being trapped between the main adhesive layer 130a and the temporary adhesive layers 140a. However, it is necessary to ensure that the temporary adhesive layers 140a will achieve the adhesive strength necessary to fix the first substrate 100 and the second substrate 200 together. Accordingly, the total length of the temporary adhesive layers 140a needs to be longer than the length of the gaps 150. For example, in a case where the length of multiple temporary adhesive layers 140a is equal to or more than two-thirds of the length of the side 120 of the first substrate 100 adjacent to the multiple temporary adhesive layers 140a, in other words, where the length of the gaps 150 is equal to or less than one-third of the length of the side 120, air may easily escape from between the main adhesive layer 130a and the temporary adhesive layers 140a, which has the effect of preventing an air bubble from being trapped between the main adhesive layer 130a and the temporary adhesive layers 140a.

Subsequently, the invention is described in more details by using a specific exemplary embodiment.

### Exemplary Embodiment 1

The first substrate 100 illustrated in FIG. 3A is a semiconductor substrate obtained by stacking various wafers and then dicing them, and has dimensions of a thickness of 1 mm, a width of 13 mm, and a length of 29 mm. Meanwhile, the second substrate 200 illustrated in FIG. 3B is a Ti-based metal substrate, and has dimensions of a thickness of 100 μm, a width of 22 mm, and a length of 39 mm. The second substrate 200 has a rectangular opening 210, and the opening 210 has dimensions of a thickness of 100 μm, a width of 11 mm, and a length of 27 mm.

Then, as illuminated in FIGS. 5A and 6A, the main adhesive 130 and the temporary adhesive 140 were applied to the first substrate 100.

Thereafter, by use of the pressure-bonding apparatus 300 illustrated in FIG. 7, the second substrate 200 was thermocompression-bonded, at a heating temperature of 100 °C for a pressure-bonding time of 60 seconds, to the first substrate 100 on which the main adhesive 130 and the temporary adhesive 140 were applied. In this process, only the temporary adhesive 140 was cured.

Thereafter, the first substrate 100 and the second substrate 200 to be thermocompression-bonded were heated in an oven (not illustrated) at 150°C for two hours, so that the main adhesive 130 was cured. Then, a substrate assembly composed of the first substrate 100 and the second substrate 200 was taken out from the oven and subjected to heat dissipation, so that the bonding of the first substrate 100 and the second substrate 200 was completed.

Meanwhile, the second substrate 200, which is the metal substrate, was peeled off from the first substrate 100, which is the semiconductor substrate. As a result of observing the resultant substrates, no air bubble trapped between the main adhesive layer 130a and the temporary adhesive layers 140a was observed. In this exemplary embodiment, the main adhesive 130 is an adhesive that cures with heating to a temperature of 150°C for one hour, whereas the temporary adhesive 140 is an adhesive that cures with heating to a temperature of 80°C for 40 seconds.

### Comparative Example

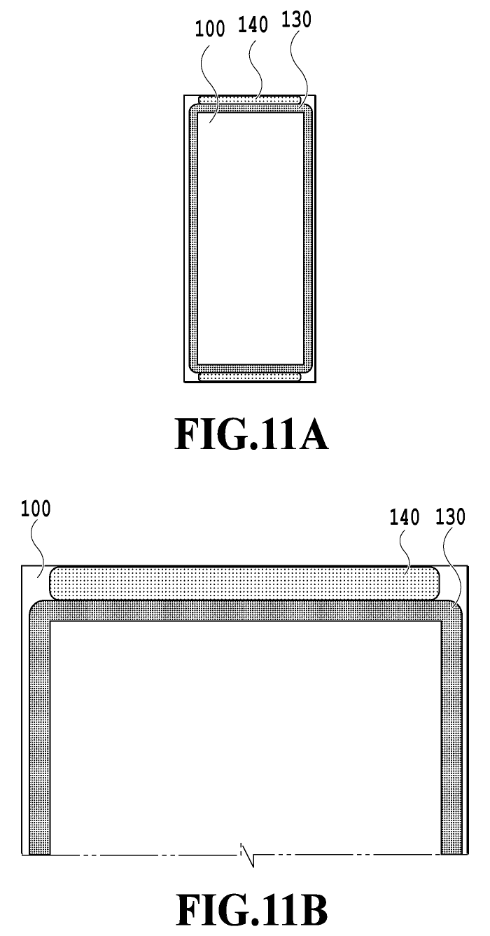

Regarding the application of the temporary adhesive in the invention, a comparative example in which no gap is provided is specifically described. In the comparative example, the first substrate 100, which is the semiconductor substrate, and the second substrate 200, which is the metal substrate, are the same as in the exemplary embodiment 1. The main adhesive 130 and the temporary adhesive 140 were applied to the first substrate 100 in continuous line shapes as illustrated in FIG. 11, in other words, the second adhesive layer 140a is provided with no gap on the first substrate 100, unlike the exemplary embodiment 1.

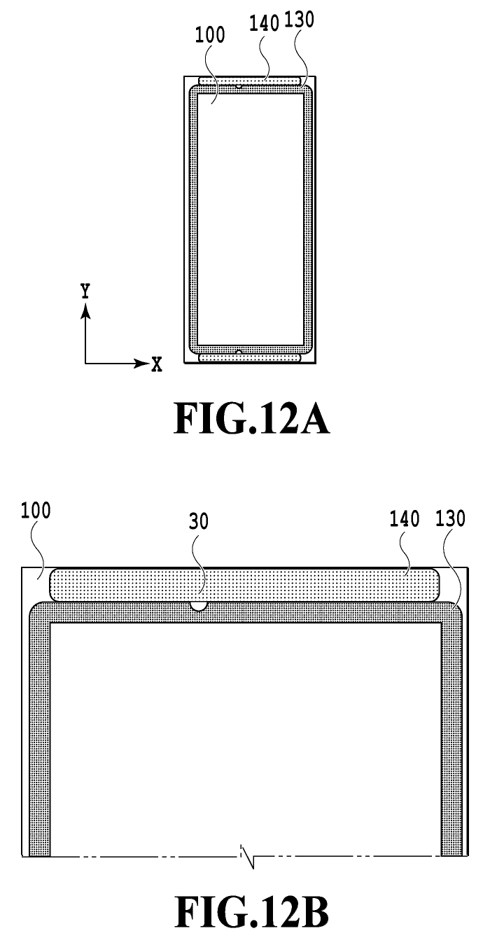

Then, the first substrate 100 and the second substrate 200 were thermocompression-bonded in the same method as in the exemplary embodiment 1. After the heating in the oven, the second substrate 200 was peeled off from the first substrate 100. As a result of observing the resultant substrates, an air bubble 30 was generated between the main adhesive layer 130a and the temporary adhesive layer 140a as illustrated in FIG. 12B. In other words, the air bubble trapped by the main adhesive layer 130a was formed. This may arise possibilities of causing problems of a damage to the first substrate 100 and a change in the shape of the main adhesive layer 130a due to internal pressure applied during heating or the like, and problems such as an insufficient adhesive strength of the main adhesive layer 130a.

On the other hand, in the exemplary embodiment 1, the intermittent application of the temporary adhesive 140 makes it possible to pressure-bond the first substrate 100 to the second substrate 200 while allowing the air to escape from the gap 150 between the layers of the temporary adhesive 140 such that the first substrate 100 is capable of being joined and fixed to the second substrate 200 without generating any leak path by an air bubble trapped between main adhesive layer 130a and the temporary adhesive 140.

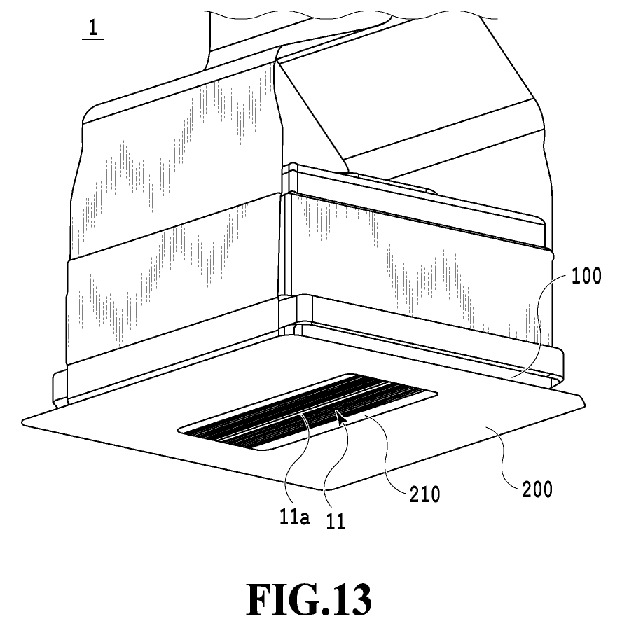

FIG. 13 is an explanatory view illustrating an inkjet print head. As illustrated in FIG. 13, an inkjet print head 1 includes an ejection chip 11 having ejection nozzles 11a, a first substrate 100, and a second substrate 200 having an opening 210. The ejection chip 11 is mounted on the first substrate 100 and covered by the second substrate 200. The ejection nozzles 11a of the ejection chip 11 is surrounded by the opening 210 of the second substrate 200 and exposed from the opening 210.

More specifically, the first substrate 100 in the embodiment is similar to the first substrate 100 illustrated in FIG. 3A, and the second substrate 200 is similar to the second substrate 200 illustrated in FIG. 3B. In other words, the ejection chip 11 in the embodiment is mounted on a substrate assembly formed in steps 401 to 405 presented in FIG. 4. Thus, since the second substrate 200, which is the metal substrate, is placed outside the ejection chip 11, the second substrate 200 may protect the ejection chip 11, and the ejection chip 11 is electrically connected to an electrical wiring portion of the inkjet print head 1 via the first substrate 100, which is the semiconductor substrate, and allows the ejection nozzles 11a to eject the ink from the opening 210 of the second substrate 200. In the embodiment, the ejection chip 11 is a silicon chip.

In the embodiment, no leak path is generated in the main adhesive layer 130a, which has strong ink resistance, between the first substrate 100 and the second substrate 200 joined together, so that the ink ejected from the ejection chip 11 has no way to reach the temporary adhesive layers 140a, which have weak ink resistance. This may avoid the problem that the adhesive strength of the temporary adhesive layers 140a is so weakened due to the ink that the temporary adhesive layers 140a peels off from the first substrate 100 and the second substrate 200, and also avoid the problem that the ink reaches the electrical wiring portion of the first substrate 100 located outside the temporary adhesive layers 140a and the electrical wiring portion shorts out due to the ink.

According to the disclosure, in continuous pressure-bonding of a first substrate and a second substrate to be joined in which a first adhesive layer formed of a main adhesive comes closer to second adhesive layers formed of a temporary adhesive, air present between the first adhesive layer and the second adhesive layers flows into a gap formed between the two adjacent second adhesive layers, which makes it possible to prevent the air from generating a leak path in the first adhesive layer.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-195383, filed November 7, 2024, which is hereby incorporated by reference herein in its entirety.

What is claimed is:

1. A joining method comprising the steps of:
applying a first adhesive in a line shape to a joining area of a first substrate to form a first adhesive layer;
applying a second adhesive in a broken line shape to the joining area of the first substrate, at a predetermined interval from the first adhesive layer in the line shape, to form a plurality of second adhesive layers with a gap formed due to the broken line shape;
bonding a second substrate to the first substrate with the first adhesive layer and the plurality of second adhesive layers and pressure-bonding the second substrate to the first substrate;
curing the plurality of second adhesive layers between the first substrate and the second substrate pressure-bonded; and
curing the first adhesive layer after the plurality of second adhesive layers are cured.

2. The joining method according to claim 1, wherein a length of each of the plurality of second adhesive layers is longer than a length of the gap.

3. The joining method according to claim 1, wherein the plurality of second adhesive layers are arranged along two opposite sides in an outer periphery of the joining area.

4. The joining method according to claim 1, wherein
the first substrate is a semiconductor substrate, and
the second substrate is a metal substrate.

5. The joining method according to claim 1, wherein
the second substrate has an opening, and
an inner periphery of the joining area corresponds to an outer periphery of the opening.

6. The joining method according to claim 1, wherein
a length of the plurality of second adhesive layers is equal to or longer than two-thirds of a length of a side of the first substrate adjacent to the plurality of second adhesive layers.

7. The joining method according to claim 1, wherein the first adhesive layer is formed of a thermosetting adhesive.

8. The joining method according to claim 7, wherein the plurality of second adhesive layers are formed of a material that cures at a lower temperature than the first adhesive layer.

9. An assembly comprising:
a first substrate and a second substrate joined together;
a first adhesive layer formed of a first adhesive in a line shape between the first substrate and the second substrate; and
a plurality of second adhesive layers formed of a second adhesive in a broken line shape and arranged adjacent to the first adhesive layer in the line shape, the plurality of second adhesive layers having a gap due to the broken line shape.

10. An inkjet print head comprising:
a first substrate and a second substrate joined together;
a first adhesive layer formed of a first adhesive in a line shape between the first substrate and the second substrate;
a plurality of second adhesive layers formed of a second adhesive in a broken line shape and arranged adjacent to the first adhesive layer in the line shape, the plurality of second adhesive layers having a gap due to the broken line shape; and
an ejection chip mounted on the first substrate, covered with the second substrate, and having an ejection nozzle, the ejection nozzle surrounded by an opening of the second substrate, and exposed from the opening.

11. The inkjet print head according to claim 10, wherein a length of the plurality of second adhesive layers is longer than a length of the gap.

12. The inkjet print head according to claim 10, wherein the plurality of second adhesive layers are formed of a material that cures at a lower temperature than the first adhesive layer.

13. The inkjet print head according to claim 10, wherein the plurality of second adhesive layers are arranged along two opposite sides of the first substrate.

14. The inkjet print head according to claim 10, wherein
the first substrate is a semiconductor substrate, and
the second substrate is a metal substrate.

15. The inkjet print head according to claim 10, wherein
a length of the plurality of second adhesive layers is equal to or longer than two-thirds of a length of a side of the first substrate adjacent to the plurality of second adhesive layers.

16. The inkjet print head according to claim 10, wherein the first adhesive layer is formed of a thermosetting adhesive.
